(19) United States
(12) Patent Application Publication
(10) Pub. No.: US 2010/0219759 A1
(43) Pub. Date: Sep. 2, 2010

(54) SHORT-CIRCUIT DETECTION METHOD AND RELATED CIRCUIT

(76) Inventor: Li-Chieh Chen, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/694,287

(22) Filed: Jan. 27, 2010

(30) Foreign Application Priority Data
Feb. 27, 2009 (TW) 098106429

(51) Int. Cl. H05B 37/02

(52) U.S. Cl. 315/129

(57) ABSTRACT

A short-circuit detection method provides a dimmer signal for driving a light source and a feedback signal which varies according to the voltage drop across the light source. When the voltage level of the feedback signal is below a reference voltage, a high-level compare signal is provided. When the voltage level of the feedback signal is above the reference voltage, a low-level compare signal is provided. When the dimmer signal is at high level and the compare signal is at low level, a high-level count signal is provided. When the count signal has switched to high level more than a predetermined number of times, a short-circuit signal is outputted.

### BACKGROUND OF THE INVENTION

1. Field of the Invention

The present invention is related to a short-circuit detection method and related circuit.

2. Description of the Prior Art

Light-emitting diodes (LEDs) are widely used as display devices If a single failure occurs to one LED of the LED string (for example, one short-circuited LED), other LEDS may be over-driven by a larger current, thereby deviating from normal brightness or causing permanent device damage. Therefore, the dimmer circuit normally provides short-circuit detection.

FIG. 1 shows a diagram illustrating a dimmer circuit 100 with short-circuit detection. The dimmer circuit 100 includes a current source 10, a switch 12, a signal generator 14, and a voltage comparator 16. The current source drives a semiconductor light-emitting device 11. The voltage levels at both ends of the semiconductor light-emitting device 11 are represented by V_{OUT} and V_{FB}, while the voltage drop across each LED is represented by V_{D}. The signal generator 14, coupled to the switch 12 and the voltage comparator 16 generates a dimmer signal V_{DIMMER} and a control signal V_{ON} for selectively turning on/off the switch 12 and the voltage comparator 16, respectively. The switch 12 controls the current path between the current source 10 and the semiconductor light-emitting device 11 according to the dimmer signal V_{DIMMER}. Therefore, the voltage level of the feedback signal V_{FB} also varies with the dimmer signal V_{DIMMER}. When turned on by the control signal V_{ON}, the voltage comparator 16 outputs a corresponding short-circuit signal V_{SH} by comparing the voltage levels of the feedback signal V_{FB} and a reference voltage V_{REF}.

FIG. 2 shows a timing diagram illustrating the operation of the dimmer circuit 100. FIG. 2 shows the waveforms of the dimmer signal V_{DIMMER}, the feedback signal V_{FB}, the control signal V_{ON}, and the short-circuit signal V_{SH}. At T2 and T4, the control signal V_{ON} switches from low level to high level, thereby turning on the voltage comparator 16: if the feedback signal V_{FB} is smaller than the reference voltage V_{REF}, the voltage comparator 16 outputs a low-level short-circuit signal V_{SH}; if the feedback signal V_{FB} is larger than the reference voltage V_{REF}, the voltage comparator 16 outputs a high-level short-circuit signal V_{SH}. For example, if all devices (such as N LEDs coupled in series) function normally when the dimmer signal V_{DIMMER} switches from low level to high level at T1, the dimmer signal V_{DIMMER} turns on the switch 12. At this moment, a voltage drop V_{D} is established across each LED due the current flowing through the semiconductor light-emitting device 11, thereby causing the feedback signal V_{FB} to fall from a high level V_{H} (about V_{OUT}) to a low level V_{L} (about V_{OUT}−N*V_{D}). In the ideal case, the feedback signal V_{FB} immediately switches from high level to low level when the dimmer signal V_{DIMMER} switches from low level to high level. Under this circumstance, the voltage level V_{L} of the feedback signal V_{FB} is lower than reference voltage V_{REF} at T2, and the voltage comparator 16 thus outputs the low-level short-circuit signal V_{SH}. On the other hand, if (N−n) LEDs in the semiconductor light-emitting device 11 become short-circuited at T5, voltage drops V_{D} are only established across n normal LEDs in the semiconductor light-emitting device 11 when the dimmer signal V_{DIMMER} switches from low level to high level at T6. At this moment, the feedback signal V_{FB} can only be lowered to a level V_{L}′ (about V_{OUT}−n*V_{D}) instead of to the ideal level V_{L} (about V_{OUT}−N*V_{D}). As the number of short-circuited LEDs increases, the voltage level V_{L}′ eventually exceeds the reference voltage V_{REF}. The voltage comparator 16 can thus notify short-circuit by outputting the high-level short-circuit signal V_{SH}.

The dimmer circuit 100 provide analog short circuit detection. In the ideal case, the feedback signal V_{FB} immediately switches from high level to low level when the dimmer signal V_{DIMMER} switches from low level to high level at T1. However in reality, a delay time T_{DELAY} is required before the semiconductor light-emitting device 11 becomes stable. For example, when the dimmer signal V_{DIMMER} switches from low level to high level at T3, the level of the feedback signal V_{FB} gradually decreases and eventually reaches the stable level V_{L} at T5. If the voltage comparator 16 is turned on before the feedback signal V_{FB} becomes stable, the detected level V_{L}′ may be higher than the reference voltage V_{REF}. Even if all devices in the semiconductor light-emitting device 11 (such as N LEDs coupled in series) function normally, the voltage comparator 16 may output the high-level short-circuit signal at T4, which causes false short-circuit alarm.

### SUMMARY OF THE INVENTION

A dimmer circuit with short-circuit detection is disclosed. The dimmer circuit comprises a signal generator configured to generate a dimmer signal for driving a light source; a voltage comparator configured to provide a compare signal and switches a level of the compare signal according to voltage levels of a feedback signal and a reference voltage, wherein the feedback signal is varies according to a voltage drop across the light source; a short-circuit signal generator configured to provide a count signal and switch the count signal to a first level when the dimmer signal is at the first level and the compare signal is at a second level; and a count circuit configured to generate a short-circuit signal according to how many times the count signal switches to the first level.

A dimmer circuit with short-circuit detection for driving a light source is also disclosed. The dimmer circuit comprises a current source; a switch for controlling a signal transmission path between the current source and the light source according to a dimmer signal; a signal generator configured to generate the dimmer signal; and a short-circuit judging circuit configured to determine whether a short-circuit occurs in the light source according to the dimmer signal and how many times a voltage level of a feedback signal drops below a voltage level of a reference voltage, wherein the feedback signal varies according to a voltage drop across the light source.

A method for providing short-circuit detection is also disclosed. The method comprises providing a dimmer signal for driving a light source; providing a feedback signal which varies according to a voltage drop across the light source; switching a compare signal from a second level to a first level when the feedback signal is below a reference voltage; providing the compare signal having the second level when the feedback signal is above the reference voltage; switching a count signal from the second level to the first level when the dimmer signal is at the first level and the compare signal is at the second level; and outputting a short-circuit signal when the count signal has switched from the second level to the first level over a predetermined number of times.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a dimmer circuit with short-circuit detection.

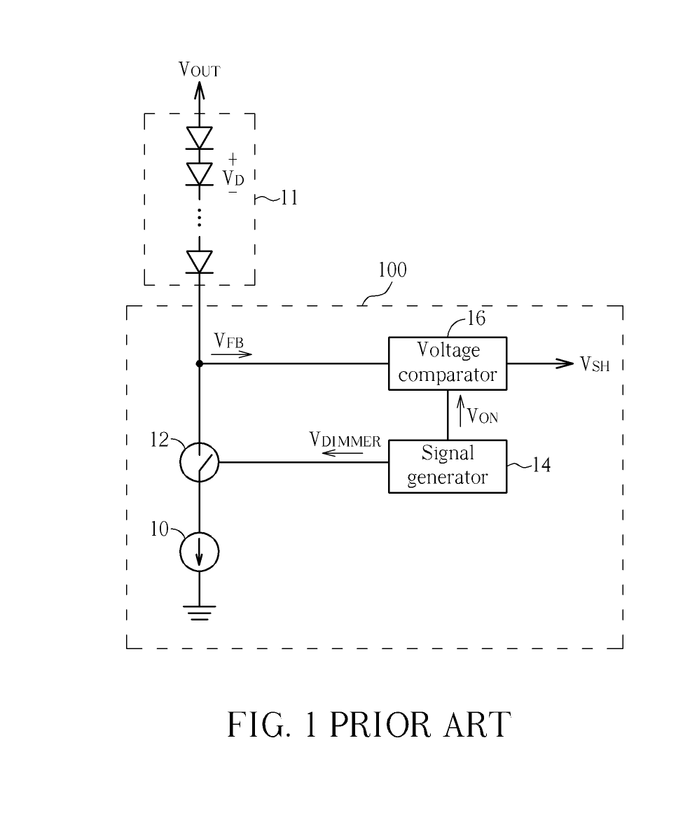

FIG. 2 is a timing diagram illustrating the operation of the dimmer circuit in FIG. 1.

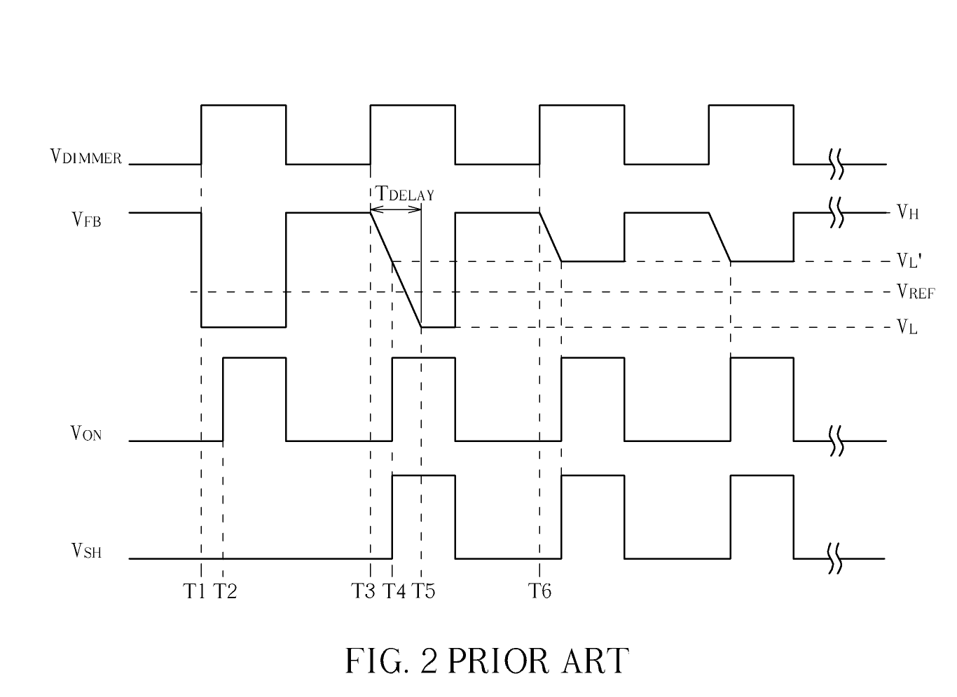

FIG. 3 is a diagram illustrating a dimmer circuit with short-circuit detection according to the present invention.

FIG. 4 is a circuit diagram of a dimmer circuit according an embodiment of the present invention.

FIG. 5 is a timing diagram illustrating the operation of the dimmer circuit in FIG. 3.

### DETAILED DESCRIPTION

Certain terms are used throughout the following description and claims to refer to particular components. As one skilled in the art will appreciate, manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. Also, the term “couple” is intended to mean either a direct or an indirect electrical connection. Accordingly, if one device is coupled to another device, the electrical connection may be through a direct electrical connection, or through an indirect electrical connection via other devices and connections.

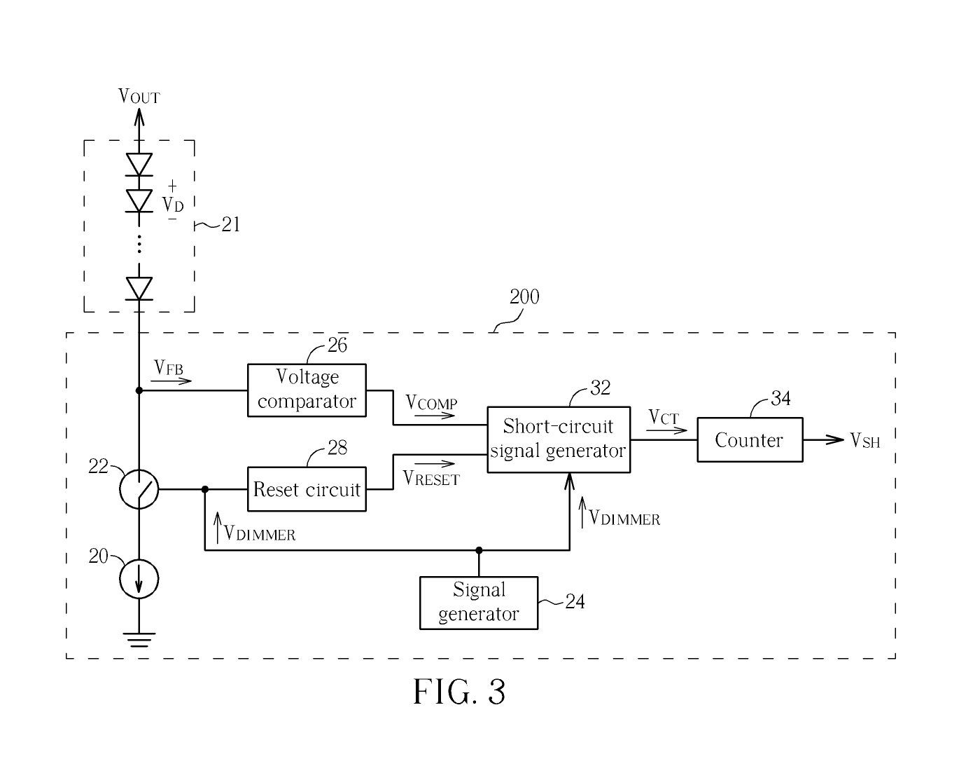

FIG. 3 illustrates a diagram illustrating a dimmer circuit 200 with short-circuit detection. The dimmer circuit 200 includes a current source 20, a switch 22, a signal generator 24, a voltage comparator 26, a reset circuit 28, a short-circuit signal generator 32, and a counter 34. The current source 20 drives a semiconductor light-emitting device 21. The voltage levels at both ends of the semiconductor light-emitting device 21 are represented by V_{OUT} and V_{FB}, while the voltage drop across each LED is represented by V_{D}. The signal generator 24, coupled to the switch 22, the reset circuit 28 and the short-circuit signal generator 32, generates a dimmer signal V_{DIMMER} for selectively turning on/off the switch 22. The reset circuit 28, coupled to the signal generator 24 and the short-circuit signal generator 32, generates a corresponding reset signal V_{RESET} according to the dimmer signal V_{DIMMER}. The voltage comparator 26, the short-circuit signal generator 32, and a counter 34 together form a short-circuit judging circuit which provides a short-circuit signal V_{SH} according to how many times the voltage level of the feedback signal V_{FB} drops below that of a reference voltage V_{REF}. The voltage comparator 26, coupled between the semiconductor light-emitting device 21 and the short-circuit signal generator 32, generates a corresponding compare signal V_{COMP} by comparing the feedback signal V_{FB} with the reference voltage V_{REF}. The voltage comparator 26 is always on during operation. The short-circuit signal generator 32, coupled to the voltage comparator 26, the reset circuit 28 and the signal generator 24, generates a corresponding count signal V_{CT} according to the compare signal V_{COMP} and the reset signal V_{RESET}. The short-circuit signal generator 32 outputs a high-level count signal V_{CT} only when receiving a high-level dimmer signal V_{DIMMER} and a low-level compare signal V_{COMP}; otherwise, the short-circuit signal generator 32 outputs a low-level count signal V_{CT}. The counter 34, coupled to the short-circuit signal generator 32, generates the corresponding short-circuit signal V_{SH} based on how many times the count signal V_{CT} switches levels.

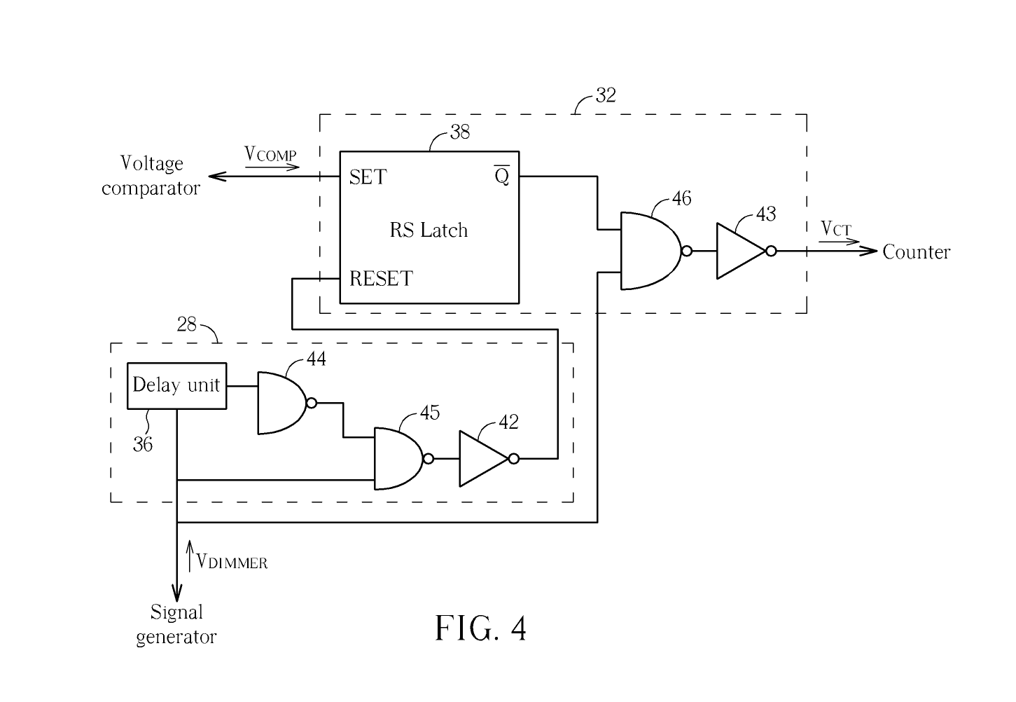

FIG. 4 is a circuit diagram of a dimmer circuit 200 according an embodiment of the present invention. In this illustrated embodiment, the reset circuit 28 includes a delay unit 36, an inverter 42 and NAND gates 44 and 45. The short-circuit signal generator 32 includes an RS latch 38, an inverter 43, and a NAND gate 46. According to the dimmer signal V_{DIMMER}, the reset circuit 28 transmits the corresponding reset signal V_{RESET} to a RESET terminal of the RS latch 38 so as to reset the status of the RS latch 38 in the previous period. When the dimmer signal V_{DIMMER} is at high level and the feedback signal V_{FB} is smaller than the reference voltage V_{REF}, the compare signal V_{COMP} received at a SET terminal of the RS latch 38 switches to high level. The RS latch 38 thus outputs a low-level signal at a Q̅ terminal, thereby generating a low-level count signal V_{CT} using the NAND gate 46 and the inverter 43. When the dimmer signal V_{DIMMER} is at high level and the feedback signal V_{FB} is larger than the reference voltage V_{REF}, the compare signal V_{COMP} received at the SET terminal of the RS latch 38 is at low level. The RS latch 38 thus outputs a high-level signal at the Q̅ terminal, thereby outputting the dimmer signal V_{DIMMER} as the count signal V_{CT} using the NAND gate 46 and the inverter 43.

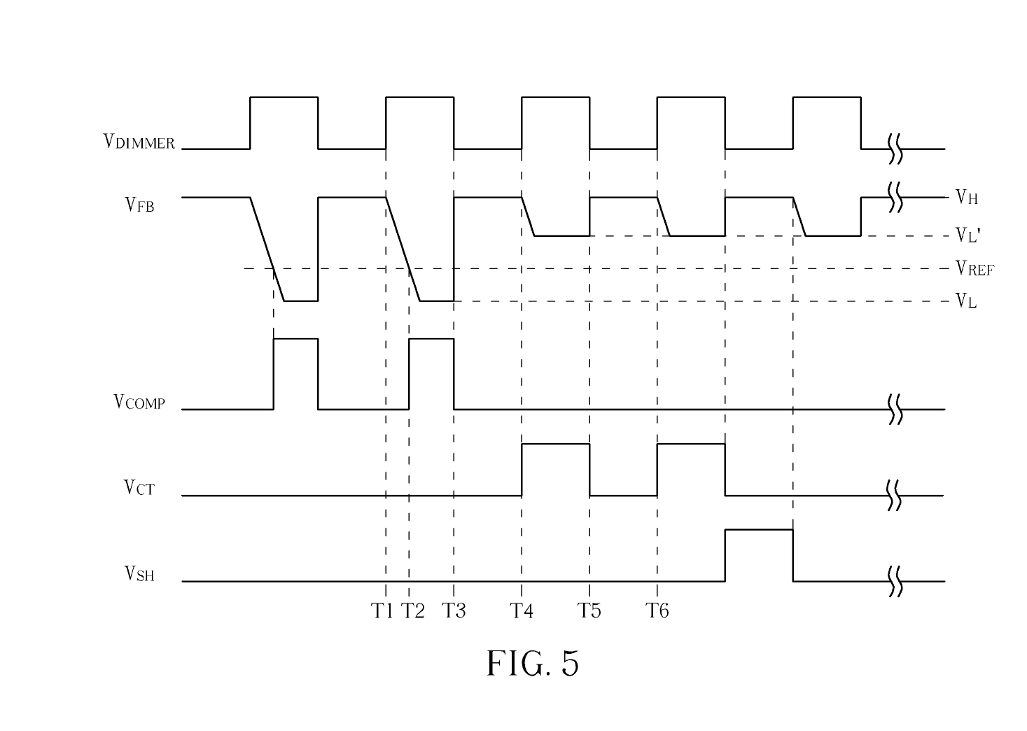

FIG. 5 is a timing diagram illustrating the operation of the dimmer circuit 200 according to the present invention. FIG. 5 shows the waveforms of the dimmer signal V_{DIMMER}, the feedback signal V_{FB}, the compare signal V_{COMP}, the count signal V_{CT} and the short-circuit signal V_{SH}. Assuming that all devices of the semiconductor device 21 (such as N LEDs coupled in series) function normally, the switch 22 is turned on when the dimmer signal V_{DIMMER} switches to high level at T1. The current flowing through the semiconductor light-emitting device 21 establishes a voltage drop across each LED, and the feedback signal V_{FB} thus gradually decreases from high level V_{H} (about V_{OUT}) to low level V_{L} (about V_{OUT}−N*V_{D}). At T2 when the feedback signal V_{FB} becomes smaller than the reference voltage V_{REF}, the voltage comparator 26 outputs a high-level compare signal V_{COMP}, the short-circuit signal generator 32 outputs a low-level count signal V_{CT}, and the counter 34 outputs a low-level short-circuit signal V_{SH}. At T3 when the dimmer signal V_{DIMMER} switches from high level to low level, the switch 22 is turned off and no current flows through the semiconductor light-emitting device 21. The feedback signal V_{FB} thus gradually rises from low level V_{L} to high level V_{H}. The voltage comparator 26 outputs a low-level compare signal V_{COMP}, while the count signal V_{CT} and the short-circuit signal V_{SH} remain at low level.

If (N−n) LEDs in the semiconductor light-emitting device 21 become short-circuited after T3, voltage drops are only established across the n normal LEDs due the current flowing through the semiconductor light-emitting device 21 when the dimmer signal V_{DIMMER} switches from low level to high level at T4. At this moment, the feedback signal V_{FB} can only be lowered to a level V_{L}′ (about V_{OUT}−n*V_{D}) instead of the ideal level V_{L} (about V_{OUT}−N*V_{D}). If the number of short-circuited LEDs exceeds a certain number, the voltage level V_{L}′ becomes larger than the reference voltage V_{REF} and the voltage comparator 26 continues to output the low-level short-circuit signal V_{SH}. The short-circuit signal generator 32 thus outputs the dimmer signal V_{DIMMER} as the count signal V_{CT}, and the counter 34 increases its count value by 1 upon receiving the high-level count signal V_{CT}. If the count value of the counter 34 does not exceed a predetermined value, the counter 34 continue to output the low-level short-circuit signal V_{SH}. If the feedback signal V_{FB} is still larger than the reference voltage V_{REF} at T6, the counter 34 continue to receive the high-level count signal V_{CT} and its count value is again increased by 1. If the count value of the counter 34 exceeds the predetermined value, the counter 34 outputs the high-level short-circuit signal V_{SH}.

The proposed dimmer circuit 200 provides short circuit detection. The short-circuit signal generator 32 outputs a high-level count signal V_{CT} only when the dimmer signal V_{DIMMER} is at high level and the compare signal V_{COMP} is at low level. The counter 34 then measures how many times the count signal V_{CT} switches levels, based on which the occurrence of a short-circuit failure can be detected. The voltage comparator 26 is always on during operation, thereby capable of providing accurate short-circuit detection without the influence of the delay time.

Those skilled in the art will readily observe that numerous modifications and alterations of the device and method may be made while retaining the teachings of the invention.

What is claimed is:

1. A dimmer circuit with short-circuit detection comprising:
a signal generator configured to generate a dimmer signal for driving a light source;
a voltage comparator configured to provide a compare signal and switch a level of the compare signal according to voltage levels of a feedback signal and a reference voltage, wherein the feedback signal varies according to a voltage drop across the light source;
a short-circuit signal generator configured to provide a count signal and switch the count signal to a first level when the dimmer signal is at the first level and the compare signal is at a second level; and
a count circuit configured to generate a short-circuit signal according to how many times the count signal switches to the first level.

2. The dimmer circuit of claim 1 further comprising:
a reset circuit configured to generate a reset signal for resetting the short-circuit signal generator according to the dimmer signal.

3. The dimmer circuit of claim 2 wherein the reset circuit includes a delay unit and a logic device.

4. The dimmer circuit of claim 3 wherein the logic device includes an inverter or a NAND gate.

5. The dimmer circuit of claim 1 wherein the short-circuit signal generator includes a latch and a logic device.

6. The dimmer circuit of claim 5 wherein the logic device includes an inverter or a NAND gate.

7. A dimmer circuit with short-circuit detection for driving alight source, the dimmer circuit comprising:
a current source;
a switch for controlling a signal transmission path between the current source and the light source according to a dimmer signal;
a signal generator configured to generate the dimmer signal; and
a short-circuit judging circuit configured to determine whether a short-circuit occurs in the light source according to the dimmer signal and how many times a voltage level of a feedback signal drops below a voltage level of a reference voltage, wherein the feedback signal varies according to a voltage drop across the light source.

8. The dimmer circuit of claim 7 wherein the short-circuit judging circuit comprises:
a voltage comparator configured to provide a compare signal and switch a level of the compare signal according to voltage levels of the feedback signal and the reference voltage;
a short-circuit signal generator configured to provide a count signal and switch the count signal to a first level when the dimmer signal is at the first level and the compare signal is at a second level; and
a count circuit configured to generate a short-circuit signal according to how many times the count signal switches to the first level, wherein the short-circuit judging circuit determines whether the short-circuit occurs in the light source according to the dimmer signal and the short-circuit signal.

9. A method for providing short-circuit detection comprising:
providing a dimmer signal for driving a light source;
providing a feedback signal which varies according to a voltage drop across the light source;
switching a compare signal from a second level to a first level when the feedback signal is below a reference voltage;
providing the compare signal having the second level when the feedback signal is above the reference voltage;
switching a count signal from the second level to the first level when the dimmer signal is at the first level and the compare signal is at the second level; and
outputting a short-circuit signal when the count signal has switched from the second level to the first level over a predetermined number of times.

10. The method of claim 9 further comprising:
determining whether the feedback signal is smaller than the reference voltage.

11. The method of claim 9 further comprising:
providing a reset signal for resetting a status of the count signal.
